(19) United States
(12) Patent Application Publication
(10) Pub. No.: US 2009/0182935 A1
(43) Pub. Date: Jul. 16, 2009

(54) MASS STORAGE DEVICE, IN PARTICULAR OF THE USB TYPE, AND RELATED METHOD FOR TRANSFERRING DATA

(75) Inventors: Andrea Pizzarulli, Civitanova Marche (MC) (IT); Gianluca Sensalari, Passerano Marmorito (AT) (IT)

Correspondence Address: EGBERT LAW OFFICES, 412 MAIN STREET, 7TH FLOOR, HOUSTON, TX, 77002, US

(73) Assignee: XANTO TECHNOLOGIES S.R.L., Torino (IT)

(21) Appl. No.: 12/299,455

(22) PCT Filed: May 17, 2007
(86) PCT No.: PCT/IB2007/001281

§ 371 Date: Nov. 17, 2008

(30) Foreign Application Priority Data
May 19, 2006 (IT) 2006A000364

(51) Int. Cl. G06F 13/00; G06F 1/26; G06F 12/00

(52) U.S. Cl. 711/103; 710/301; 713/300; 711/115; 711/E12.001

(57) ABSTRACT

A mass storage device of the present invention includes one or more memory elements and a logic module adapted to interface the one or more memory elements for exchanging data according to a data exchange protocol, in particular of the USB type, through a first port. The mass storage device has a module for detecting the presence of a power voltage associated with a first connector of the first port, and the logic module can set the storage device to either a Host or a Function device configuration depending on the detection carried out by the module for detecting the presence of a power voltage. The device also includes a second port adapted to implement a direct data exchange with further storage devices. The device additionally offers the possibility of communicating with radio or optical wireless ports exchanging data through a data bus, e.g. of the USB type.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a mass storage device of a type comprising one or more memory elements and a logic module adapted to interface said one or more memory elements for exchanging data through a first connector according to a data exchange protocol, in particular of the USB type.

More in general, the present invention relates to techniques for transferring data between two or more mass storage devices through a bus, preferably of the USB type, in particular in the absence of a computer, e.g. a Personal Computer, connected on said bus. The invention will be described with particular reference to mass storage devices provided with a USB connector and flash memory, i.e. the so-called ‘USB keys’, but it is clear that the invention may also be applied to any mass storage device capable of interfacing over a bus for exchanging data.

2. Description of Related Art Including Information Disclosed Under 37 CFR 1.97 and 37 CFR 1.98.

Current mass storage and data transfer systems often use the USB (Universal Serial Bus) protocol. Communication takes place according to point-to-point connections between a host device (‘Host’), the bus being controlled by only one of said host devices, and a function device or peripheral (‘Function’). Hereafter, the present description will refer to ‘Host device’ and ‘Function device’, as well as to ‘Hub device’ to designate a USB device adapted to provide interconnection of other USB devices. For a complete description of the meaning of said terms and of the USB protocol, please refer to the USB 2.0 Specification (Universal Serial Bus Specification, Compaq Hewlett-Packard Intel Lucent Microsoft NEC Philips, Revision 2.0, Apr. 27, 2000).

Said USB 2.0 Specification, like the previous 1.1 version, requires the Host device to provide a power voltage over a line called Vbus for use by a Function device, i.e. non-Host, connected to said line and in general to the USB bus. According to the USB protocol, only one Host and one non-Host can be present on a USB bus.

FIG. 1 shows a diagram of the physical level of a USB bus 10, indicating the power line Vbus with a corresponding ground line GND, as well as two data lines D+, D−, respectively positive and negative.

A Function device may either be powered through said power line Vbus or be self-powered. Of course, a Function device may also be able to switch to either type of power supply. In today's systems, therefore, a mass storage device plays a “Function” device role, whereas a computer such as a Personal Computer (PC) implements a “Host” device functionality in its operating system (OS).

This set represents a basic USB data transfer system known in the art, exemplified in the diagram of FIG. 2, between a Host USB device H, implemented in a Personal Computer 11, and a first mass storage device 12 and a second mass storage device 13, both associated with flash memory cards, which implement two corresponding Function USB devices F1 and F2.

In this system, wherein the Personal Computer 11 is connected on the USB bus 10 through a HUB in order to transfer data between the first mass storage device 12 and the second mass storage device 13, the Personal Computer 11 works as a Host device H and must copy the contents of a Function device, e.g. F1, to its own back-up memory MB, and then transfer the same contents to the other Function device F2.

It should be noted that the USB bus, though called ‘bus’ in the USB standard, does not exactly correspond to the general concept of a data bus the use of which is determined by peripheral contention, since it generally makes use of a Hub and operates essentially in a point-to-point mode. It follows that such a data transfer system suffers from the drawback that it requires a Host device associated with a Personal Computer or the like. This means that it is not possible to transfer data between two standard Function devices lacking the additional ID pin without using a Personal Computer operating as a Host device, or in general a third similar connection device working as such. However, a USB Specification supplement has been proposed which is called ‘USB On-The-Go (OTG)’ (downloadable from World Wide Web address http://www.usb.org/developers/onthego/OTG Supplemental 2.pdf).

According to said USB OTG Specification, some devices may operate simultaneously as Host and non-Host devices. Such devices are called ‘dual-mode’ devices, i.e. capable of operating in a double mode as both host and peripheral, i.e. Host and Function. According to the USB OTG nomenclature, the initial Host device is called A-Device, while the initial Function device is called B-Device. The initial roles are determined by the orientation of the cable. Dual-mode devices employ a female connector called mini-AB. The mini-A male connector, the mini-B male connector and the mini-B female connector are equipped with an additional pin in addition to the existing four pins of the standard USB bus, whose additional pin is called ‘ID pin’ and provides different electrical identifiers at the cable ends. Said ID pin is grounded in the mini-A connector, while it is left floating in the mini-B connector. The OTG device that receives the grounded ID pin is the default Host device, while the device with the floating ID pin is the default Function device.

It follows that standard USB devices such as, for example, flash memory cards contained in USB keys, cannot apply said USB OTG negotiation protocol because their connectors have no ID pin. In this regard, U.S. Pat. No. 6,993,618 has disclosed a device for exchanging data between Flash memory cards and USB devices which can configure themselves as either Host or Function based on whether a polling sequence identifies or not the presence of a connected USB device. Such a device provides a data exchange interface suffering from the drawback that it is another device to be added to those between which a direct exchange of data to be associated with Flash cards is to be earned out, which cards per se have no data access device, and that its operation requires a rather complex, difficult and, as aforesaid, indirect sequence of steps. Moreover, such a device does not allow data to be transferred between two USB devices. As a matter of fact, the above device has no USB port other than the one dedicated to exchanging data with the Host PC.

International patent application WO 2006/017553 describes a flash-type memory, in particular a USB key, having a male connector and a female connector. The female connector can be coupled to a male connector of a similar flash-type memory for the purpose of exchanging data between the two flash memories. However, the mutual recognition of the roles that the two memories must play, i.e. which memory must operate as a Host and which memory must operate as a Function, does not occur automatically, but depends on a manual setting entered by the user through an appropriate button being present on a housing associated with the flash-type memory.

International patent application WO 2004/034266 describes a system comprising two Host devices sharing the same bus on which the device which is to enter the Host state is designated by detecting the voltage difference on the power line Vbus shared by both devices. However, this discrimination is only possible if the power voltage on the line Vbus of one device is kept at a lower level than that of the other device.

### BRIEF SUMMARY OF THE INVENTION

The present invention aims at overcoming the above-mentioned drawbacks by proposing a solution which allows data to be transferred directly between two or more mass storage devices through a bus, preferably of the USB type, in particular without using a computer working as a Host device connected on said bus, preferably of the USB type, and which provides rearward compatibility with devices, preferably of the USB type, lacking suitable connectors specifically adapted to implement dual-mode standards such as USB OTG. In accordance with the present invention, this object is achieved by means of a device incorporating the features of the appended claims, which are intended as an integral part of the technical teaching of the invention. The present invention also relates to a corresponding method.

### BRIEF DESCRIPTION OF THE SEVERAL VIEWS OF THE DRAWINGS

The invention will now be described, by way of non-limiting example, with reference to the annexed drawings.

FIG. 1 and FIG. 2 are schematic views, illustrating the prior art and have already been described.

FIG. 3a is a schematic view, showing a general diagram of a mass storage device according to a first embodiment of the invention, wherein the storage device comprises only one re-configurable port.

FIG. 3b is a schematic view, showing a general diagram of a mass storage device according to a second embodiment of the invention, wherein the storage device comprises two separate ports.

FIGS. 4a and 4b shows flow charts representing procedures implemented in the devices of FIGS. 3a and 3b.

FIG. 5 is a schematic view showing a detail of an embodiment of the device of FIGS. 3a and 3b.

FIG. 6a and FIG. 6b are schematic views of two variants of the embodiment of FIG. 5, respectively.

FIG. 7 shows a detailed schematic view of the device of FIGS. 3a and 3b.

FIG. 8 is a perspective view of the device of FIG. 5.

### DETAILED DESCRIPTION OF THE INVENTION

In brief the invention relates to amass storage device, in particular of the USB type, modified for the purpose of providing a direct data transfer system, said modified mass storage device comprising a dedicated hardware module which allows said modified mass storage device to take on both roles as a Host device and as a Function device within the scope of a data exchange protocol, in particular a USB protocol. Said modified mass storage device therefore behaves as a normal mass storage device, i.e. as a Function device for storing and transferring input/output data, also capable of operating as a Hub, i.e. a common connection point for other devices on the network, in particular of the USB type, if necessary, or as a superintendent or master device, i.e. a Host device, capable of coordinating the bus, in particular of the USB type, for transferring data received and sent by the device itself or received and sent by another storage device. The proposed device implements a dedicated software procedure which, together with dedicated hardware, controls the data transfer system in order to discriminate between a Host device role and a Function device role depending on the nature, in particular of the USB type, of the devices connected to access ports, in particular connectors, of the modified storage device. The proposed direct data transfer system allows two or more users of storage devices, in particular of the USB type, at least one of them using a storage device modified with the proposed system, to transfer data without having to use a computer.

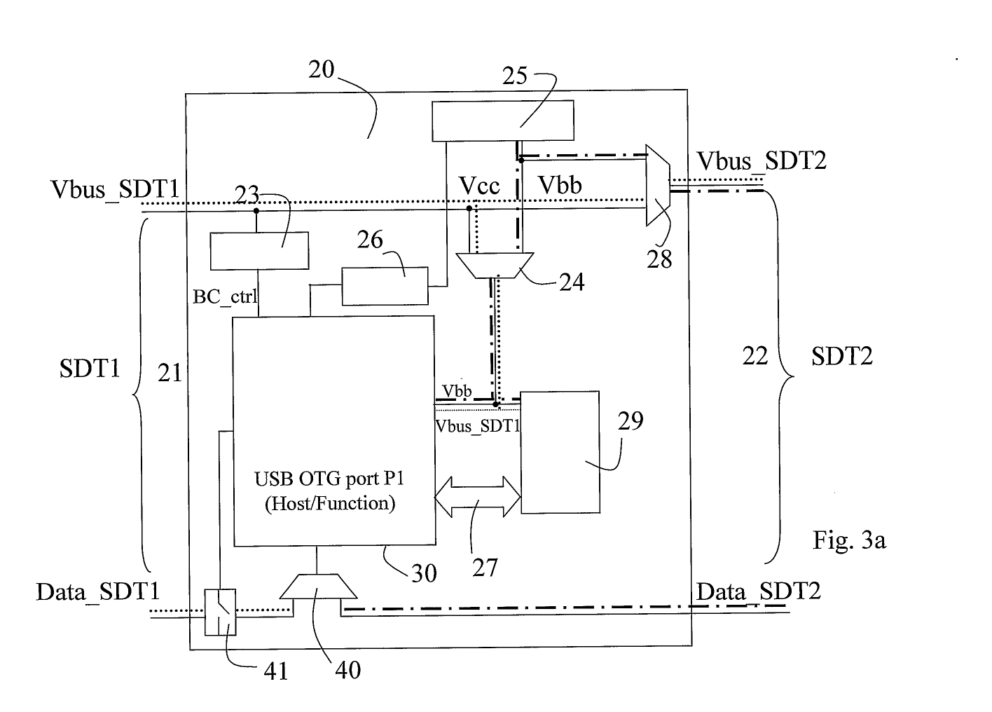

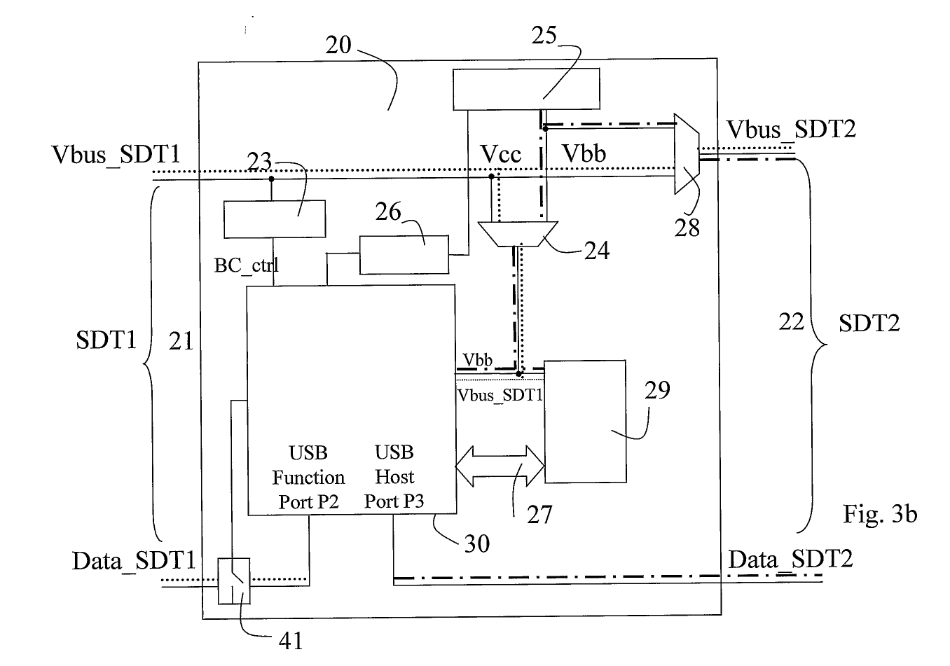

FIG. 3a shows a block diagram of a mass storage device implementing said direct data transfer system between two or more mass storage devices over a USB bus, designated as a whole by reference numeral 20. Said device comprises a male connector or port 21 and a female connector or port 22, both being of a type compatible with USB connectors, which represent access ports for exchanging data with external devices. For storing or transferring data between two devices, the storage device 20 behaves as a Hub/Function device when it is connected through the connector 21 to a first USB device, designated SDT1 in FIG. 3a, which operates as a Host device. The first USB device SDT1 may be a Personal Computer or another storage device 20 or any USB device powered by the power line Vbus, as detailed below. On the contrary, the storage device 20 operates as a Host device when a USB device, designated SDT2 in FIG. 3a, is plugged into its female connector 22.

The storage device 20 comprises a dedicated logic circuit 30 set up for handling the transition from Host to Hub/Function configuration of the storage device 20. This dedicated logic circuit 30 may be based on a controller such as a Dual Role USB Controller defined in the OTG standard.

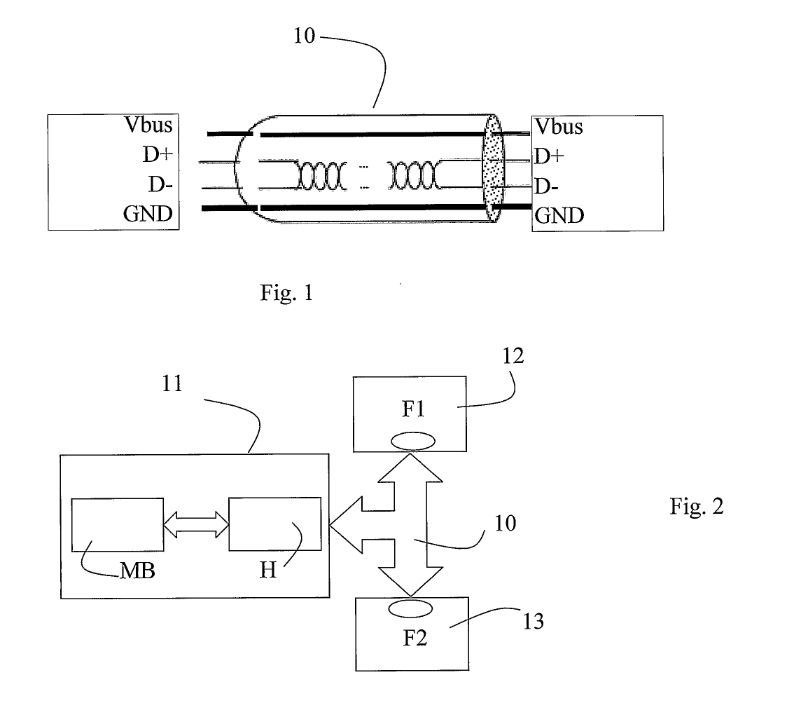

A first power line Vbus_SDT1 and a first data line Data_SDT1 start from the male connector 21 in the storage device 20. The first power line Vbus_SDT1 essentially corresponds to the power/ground lines Vbus and GND, whereas the first data line Data_SDT1 corresponds to the data lines D+ and D− of the USB bus 10 of FIG. 1.

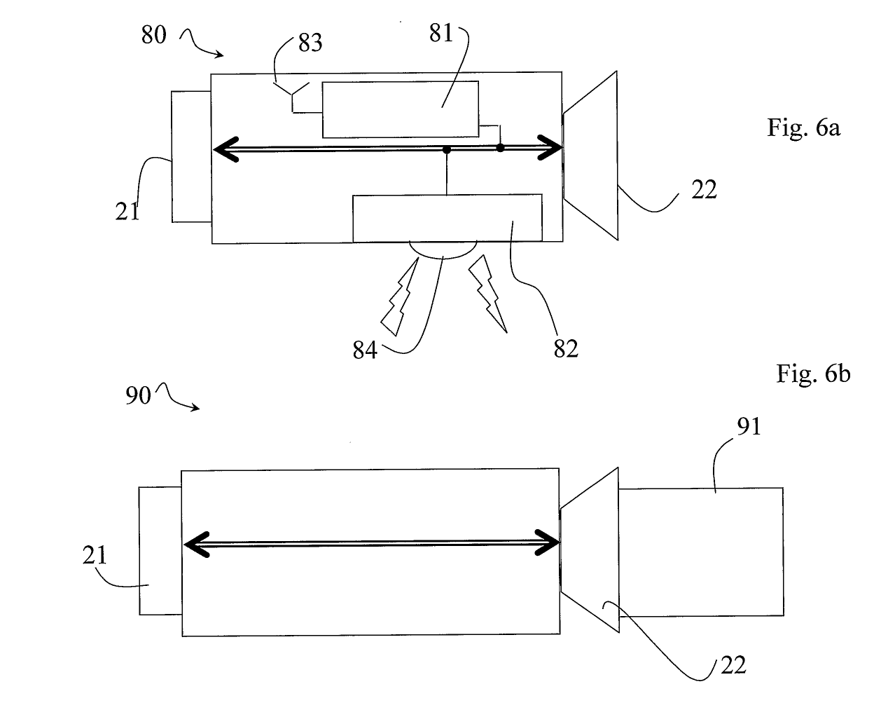

A power detection circuit 23 is connected on the first power line Vbus_SDT1 for detecting the presence or absence of a power voltage Vcc, which is then notified to an input of the dedicated logic circuit 30. Said power detection device 23 may be implemented in several ways. A typical implementation will now be described by way of example. FIG. 7 illustrates a quantizer circuit 70 essentially comprising an operational amplifier 71 of the rail-to-rail type, i.e. capable of accepting inputs having voltage levels equal to or lower than its own power voltage, which uses half the input voltage, in this case the voltage of the first power line Vbus_SDT1, as a reference threshold. A polarization voltage generator 73 is connected to the other input of the operational amplifier 71. The operational amplifier 71 is powered by the same first power line Vbus_SDT1, and its output PW_Detect is grounded through a high-impedance load resistance 72. The first power line Vbus_SDT1 is placed on the input side of the operational amplifier 71, which has high impedance. By reading the values of the output PW_Detect of the operational amplifier 71, it is possible to determine whether the first power line Vbus_SDT1 is on or off. In fact, the output PWJDetect of the operational amplifier 71 will be low (logic zero) when the voltage on the first power line Vbus_SDT1 is null or below half the rated value. The output PWJDetect will be high (logic one) when there is voltage on the first power line Vbus_SDT1 .

The storage device 20 also comprises a battery 25 controlled by a battery control circuit 26, in turn driven by a signal, i.e. a battery control flag BC_ctrl output by the dedicated logic circuit 30. The first power line Vbus_SDT1 is also one of the inputs of a multiplexer 24, the other input of which receiving a battery voltage Vbb generated by the battery 25. The output of said multiplexer 24 is provided in parallel both to an input of the dedicated logic circuit 30 and to an internal memory 29, essentially consisting of a typical flash memory card used in USB keys. The dedicated logic circuit 30 and the internal memory 29 communicate through a memory interconnection interface 27.

There is therefore another multiplexer 28, the two inputs of which receive the line Vbus_SDT1 and the battery voltage Vbb of the battery 25, and the output of which is provided as a second power line Vbus_SDT2 to the female connector 22. Said female connector 22 also comprises a data line Data_SDT2 coming from the dedicated logic circuit 30, through a multiplexer 40 that receives the data line Data_SDT1 of the device SDT1. A switch 41, arranged upstream of the multiplexer 40, closes or opens depending on whether the mass storage device 20 is connected to a device SDT1 or to a device SDT2. Thus, the logic module 30 has only one logic port P1 which can be re-configured as either Host or Function (e.g. an OTG port).

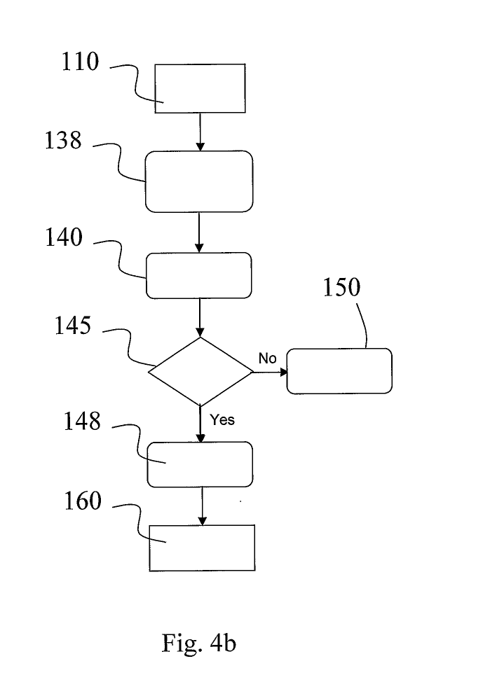

The multiplexers 24 and 28 have such an initial setting that, when the first power line Vbus_SDT1 is on, they are switched to the external power voltage Vcc by default. This allows the storage device 20 to operate in the conventional manner, without needing an on/off pushbutton, when connected to a PC. The storage device 20 also comprises, as shown in FIG. 5 wherein such features are clearly visible, a user interface and the above-mentioned on/off push-button.

A description will now be provided of the possible configurations of the proposed storage device 20 according to the Host or Hub/Function device connected to its male connector and/or female connector.

For a better understanding, in FIG. 3a, a dotted line indicates power and data paths associated with the configuration as a Hub/Function device, whereas a dot-dashed line indicates power and data paths associated with the configuration as a Host device. In a first case, when the storage device 20 is connected to a Host device, said storage device 20 plays the Hub/Function device role and loses all capabilities of a Host device. When the storage device 20 is set up with the Hub/Function configuration, the following will occur:

If the storage device 20 is connected to a Host device such as a Personal Computer, said battery 25 will be recharged through the battery charge control circuit 26.

If the corresponding battery control flag BC_ctrl transmitted over the first power line Vbus_SDT1 is on, then the battery 25 will not be recharged. The battery control flag BC_ctrl is a special control variable sent by storage devices 20 modified according to the invention on the USB bus 10. Therefore, only another storage device 20 modified according to the invention can control the value of said battery control flag BC_ctrl and turn it on, so as to avoid recharging a storage device 20 with another storage device 20, which by definition has a limited charge available in its battery 25.

A possible implementation of this functionality may be as follows: the male connector of a first device 20 is connected to the female USB connector of a second device 20, and the second device 20, which operates as a Host, recognizes the first device 20 as a 20-type device having recharging capability through a female USB connector, and sends a service flag file through the USB bus to a specific address in the memory of the first device 20 and/or a file having a specific file extension, e.g. “.rad”. The first device 20, the recharging system of which is initially disabled, will not turn on the recharging circuit if the service flag is on. When the first device 20 is disconnected from the second device 20, the first device 20 will automatically delete the service flag file and return to its initial state.

If a detected power flag PW_detect, sent over the bus by the power detection circuit 23 following the detection of the presence of power voltage Vcc on the first power line Vbus_SDT1, is on, i.e. the Host system connected to the male connector 21 is supplying power voltage Vcc, the storage device 20 will behave as a Hub/Function device. In particular, it will also behave as a Hub device when there is also another device connected to the female connector 22, or it will only behave as a Function device when no other device is connected to the female connector 22. The storage device 20 will therefore put the Host device connected to the male connector 21 in communication with its own internal memory 29 or with a second USB device SDT2 plugged in the female connector 22. The detection of the presence of said second USB device SDT2 may take place according to known USB techniques.

In this configuration, the storage device 20 behaves as a Hub device with an incorporated Function device, i.e. the internal memory 29, which can transfer data within the scope of the standard USB protocol. Unlike the above first case, in a second case only the second USB device SDT2 with a male connector is plugged into the female connector 22 of the storage device 20. Said second USB device SDT2 may be either another storage device 20 or a normal mass storage device such as a standard USB key. In this second case, the dedicated logic circuit 30 of the storage device 20 configures itself as a Host device.

When the storage device 20 is set up with the Host configuration, the following will occur: when the device is turned on through an appropriate on/off push-button designated 36 in FIG. 5, a dedicated circuit self-powered by the battery 25, the functions of which are in this embodiment incorporated in the same dedicated logic circuit 30, is activated by the same on/off push-button 36 and verifies the presence of voltage on the first power line Vbus_SDT1 through the power detection circuit 23. If there is no voltage on the power line VbusjSDT1, then it will set up the dedicated logic circuit 30 as a Host and switch the multiplexers to battery voltage Vbb. It should be noted that, in general, the mass storage device 20 behaves as a normal USB key (Hub/Function). Plugging any device into the connector 22 will trigger no operation. This mode of operation is preferred when the battery 25 has limited capacity. Vice versa, when the battery 25 is a high-capacity and/or rechargeable one, it will be possible to activate a watch-dog circuit allowing the device to automatically detect a device connected to the female connector 22 through known USB techniques, e.g. by executing a polling procedure for cyclically checking the state of the power detection circuit 23 in order to make sure that the device is still in the Host condition. The dedicated logic circuit 30, operating as an initialized Host device, outputs a flag signal BC_ctrl to the USB device SDT2 connected to the female connector 22. If the device SDT2 can recognize the flag BC_ctrl, i.e. it is a storage device 20, it will not allow its own battery to be recharged;

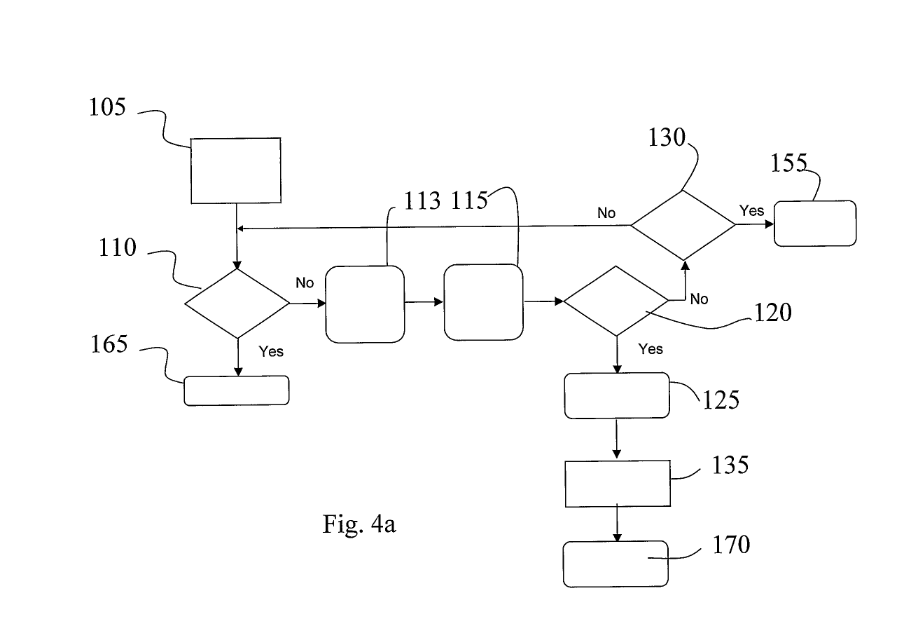

The storage device 20 plays the Host device role controls the transfer of data between devices according to the standard USB protocol. Said transfer may be checked through a display comprised in the user interface of the storage device 20. As a Host device, the storage device 20 communicates with the internal memory 29 through the memory connection interface 27, which is a parallel interface or the like. The first power line Vbus_SDT1 is not connected to the USB bus. At this stage, only the second power line Vbus_SDT2 and the data line Data_SDT2 are connected to the USB bus 10. A dedicated control procedure handles the communication between the dedicated logic circuit 30 and the interface 27. The same procedure, detailed in FIG. 4, allows to handle the data transfer according to an external user interface. In this second case, therefore, all circuits of the storage device 20 are powered by the battery 25.

In this second case, when the dedicated logic circuit 30 is set up as Host and a USB device SDT1 is connected to the male connector 21. The detected power flag PW_detect goes high, thus causing a system interrupt which indicates that the storage device 20 has been connected to a computer or another Host device (provided with the line Vbus). In such a situation, the storage device 20 will complete any ongoing critical operations (e.g. data exchange with port 22) and will then return to a Hub/Function configuration described in the above first case, with the multiplexers 24 and 28 switched to power voltage Vcc.

It should also be noted that, if the female connector 22 of the storage device 20 remains disconnected for a certain period of time after the storage device 20 has been set up as a Host device, said storage device 20 will turn itself off in order to preserve the charge of the battery 25. If a non-rechargeable battery is used, the recharging functions can be overridden, e.g. through a specific selector, or the battery recharging circuit can be omitted.

In the embodiment example of FIG. 3b, wherein the logic module has both a dedicated Host-type port P2 and a dedicated Function-type port P3, a conflict might arise as to the management of the memory 29 in the event that the device 20 were used simultaneously as Function, e.g. because it is connected to a PC through the male connector 21, and as Host, e.g. because a USB key is connected to the female connector 22. Such a conflict might occur if the user tried to transfer the same data simultaneously to both the male connector 21 and the female connector 22. For this reason, after having detected that it is connected to a Host PC through the male connector 21 by detecting the power flag PW_Detect, the device 20 will disable the user interface in order to prevent said conflict from occurring, while still allowing the female connector 22 to be used as a Hub.

FIGS. 4a and 4b show two flow charts representing a management procedure implemented by the storage device 20, in particular by the logic circuit 30. FIG. 4a shows the management procedure in detail with reference to the case wherein the storage device 20, once turned on through a specific push-button, is not plugged into a Host USB device, such as a personal computer. Step 105 represents the start of the management procedure when the storage device 20 is turned on through the on-off push-button 36. A subsequent test step 110 then checks whether a device is connected to the male connector 21. If yes, the procedure will stop at step 165, and the mass storage device 20 will remain in its usual Function state. If the response is No, at step 113 the device 20 will switch itself through the multiplexer 24 to receive a battery voltage Vbb generated by the battery 25. Subsequently, at step 115, the Host device configuration will be applied. A test step 120, next to step 115, then checks whether a USB device SDT2 is plugged in the female connector 22.

If the response at step 120 is Yes, the battery control flag BC_ctrl will be sent during step 125 and the storage device 20 will complete its configuration as Host USB device H at step 135. A data exchange step 170 may then follow between the device 20 and any device connected to the female connector 22.

If the response at step 120 is No.step 130 will verify the passing of a predefined number of seconds before a USB device SDT is plugged into the female connector 22. If said number of seconds elapses with no connection being detected, the storage device 20 will be turned off at step 155. Otherwise, control will return to test step 110. FIG. 4b shows a flow chart representing the behavior obtained when the presence of a USB device SDT1 is detected on the connector 21 at step 110.

If the response is Yes at step 110, i.e. if it is detected that a USB device SDT1 is connected to the male connector 21, step 138 will check that the multiplexers 28 and 24 are switched to Vcc (this will only take place following a system interrupt as previously described, in that the multiplexers are switched to Vcc by default). Then step 140 sets the storage device 20 to the Hub/Function configuration. A next step 145 therefore checks for the presence of an active battery control flag BC_Ctrl. If the battery control flag BC_ctrl is absent or off, a step 150 for recharging the battery 25 will be carried out. If the flag BC_ctrl is on, step 148 will disable the recharging function and will be followed by step 160, wherein the configuration as a Hub/Function USB device F will be completed.

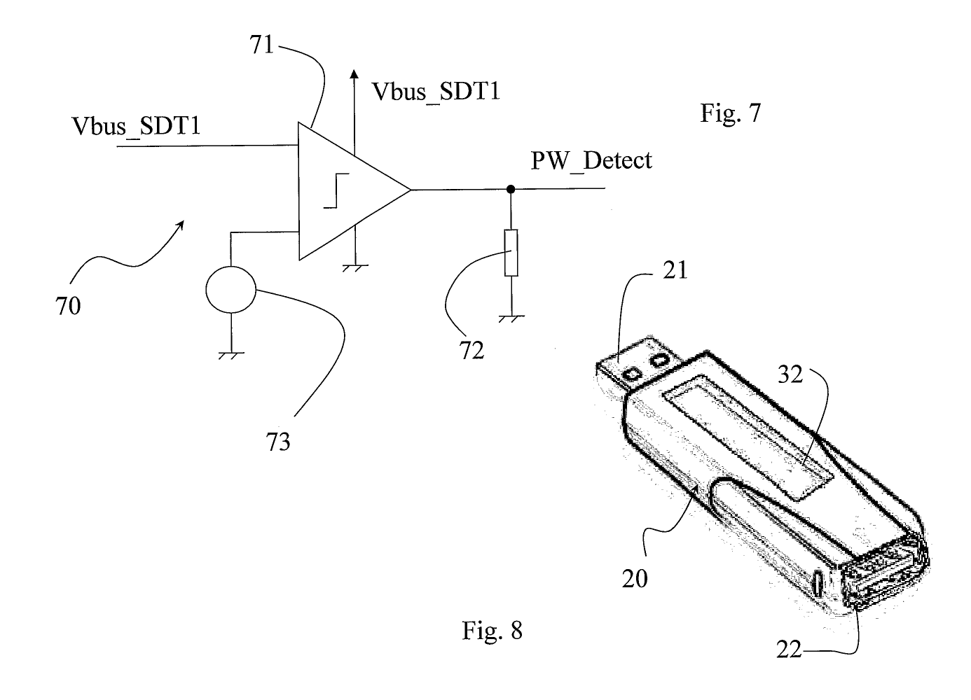

FIG. 5 shows a possible embodiment of a housing for installing the storage device 20 within a USB key, which housing comprises a body 31 containing the circuits shown in FIGS. 3a and 3b, with the male connector 21 on one end and the female connector 22 on the other end. The body 31 has a display 32 and data transfer control keys including a key 34 for selecting the device connected to the connector 21 or 22, i.e. left or right, a key 35 for scrolling and selecting the files, a key 36 for turning on/off the device 20, and a key 37 for selecting and transferring the file. FIG. 8 is a schematic perspective view of the storage device 20 showing the conventional four-pin USB connectors 21 and 22.

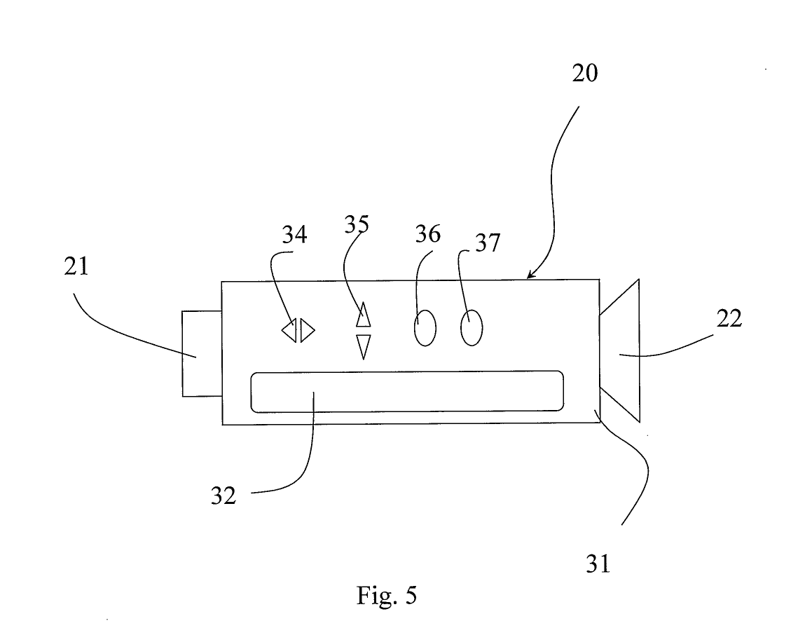

FIG. 6a shows a storage device 80 which represents a variation of the mass storage device 20 shown in FIGS. 3a and 3b. Said device 80 is substantially similar to the device 20, and comprises two interface circuits, i.e. a wireless radio interface circuit 81 and an infrared interface circuit 82, which transmit and receive through an antenna 83 and an optical transceiver 84, respectively. In particular, the wireless interface circuit 81 may operate according to the Bluetooth, Wi-Fi or USB Wireless standards, whereas the infrared interface circuit 82 may for example operate according to the IrDA (Infra Red Data Association) protocol. The wireless interface circuit 81 and the infrared interface circuit 82 are set up as supplementary ports in addition to the female connector 22, which ports allow data to be exchanged with devices having homologous interfaces. In fact, the circuits 81 and 82 are connected to at least the internal data lines of the system 80. The wireless transfer over the wireless circuits 81 and 82 can be activated by a corresponding file selection and transfer key similar to key 37 of FIG. 5. Of course, the mass storage device 80 may only comprise either the radio circuit 81 or the infrared circuit 82, just as it may possibly lack the female connector 22.

If the storage device 80 is used in the Function mode, e.g. when connected to a PC through the male connector 21, the storage device 80 may be used as a hardware key or “dongle”, the wireless management functions being carried out by the Host PC. In particular, the data transferred from an external device to the storage device 80 are sent directly to the Host PC without passing through the memory 29 of the storage device 80, thus preventing any problems due to memory management conflicts.

Also for preventing any memory management conflict from occurring, if the mass storage device 20 is not connected to a PC, data is being transferred to the local memory 29 of the device 20 in one of the possible modes implemented by the device 20, e.g. through the female USB connector by using a USB key, via Bluetooth by using a mobile telephone, or via infrared communication, and then all of a sudden the user decides to plug the device 20 into the PC, the system will not enable the data lines Data_SDT1 and Data_SDT2 on the connector 21 side until the data transfer operations are completed. FIG. 6b shows a further embodiment, designated by reference numeral 90, of the mass storage device according to the invention, wherein an adapter 91 placed on the female connector 22 is configured for exchanging data with external devices through a Bluetooth protocol and to adapt and convert the signal according to the USB standard for the device 90 to receive it through the female connector 22. By way of example, said adapter 91 may be a D-Link PersonalAir™ DBT-120 device. Of course, the adapter 91 may alternatively operate according to other wireless radio protocols such as those mentioned above, or to infrared protocols, or to wired protocols in general.

The device according to the invention has the following additional features.

The mass storage device 20,80,90 may also have a port (not shown) for connecting a memory module, e.g. of the “mini SD” type, in order to expand the internal memory 29 of the mass storage device 20.

When the device 20 is connected to the PC, the file system of the device 20 is projected into the file system of the PC, thus ensuring file system management univocity. In this manner, any read or write operations involving the file system of the device 20 can be executed directly from the PC.

The mass storage device 20,80,90 may also be used as: a) an audio/video file player, in particular of the MP3, WAV, MPEG, Real Player, Windows Media Player type; b) a sound/voice recorder, by using a USB or Bluetooth headset or a specific wireless interface, or by implementing suitable jacks on the mass storage device itself, c) an arbitration device between one or more devices connected to said mass storage device 20,80,90, e.g. of the Bluetooth type, for carrying out functions such as: cryptography between a mobile telephone and Bluetooth earphones connected thereto, thus allowing for encrypted telephone conversations which cannot be intercepted. Switching between a call on a mobile telephone and music played in the device 20,80,90; and other types of arbitration; d) an infrared transceiver, e.g. operating as a remote control for controlling remote devices; e) a USB-to-stereo audio adapter with built-in jack and microphone.

The mass storage device 20,80,90 may require the user to enter a personal identification number (PIN) for the purpose of preventing any fraudulent use of the device.

The system management software and any applications are updated with the following procedure: i) the file to be updated is transferred to the mass storage device 20,80,90; ii) a “software update” option is selected through the user interface; iii) the mass storage device 20,80,90 asks the user, through the display 32, to connect the device 20,80,90 to a self-powered device, e.g. a PC, so as to avoid power drops as the software is being updated; iv) when the device 20,80,90 sees that it is being powered by an external source, it disables internally the data lines Data_SDT1 and Data_SDT2 of the port 21 and starts the software update without any risks of power drops or conflicts with the connected system; v) when the update is complete, the device 20,80,90 displays an ‘update complete’ message on the display 32 and the device 20,80,90 can be used in the normal manner.

The mass storage device described herein by way of example may be subject to many possible variations without departing from the novelty spirit of the inventive idea; it is also clear that in the practical realization of the invention the illustrated details may have different shapes or be replaced with other technically equivalent elements. For example, the invention has been described herein with reference to a USB-type data exchange protocol. However, it may also be implemented with other types of data exchange protocols providing at least one power line, one ground line and data exchange lines. One such protocol is, for example, the UART protocol.

The direct data transfer device according to the invention thus advantageously allows data to be transferred directly between two or more mass storage devices through a bus, preferably of the USB type, in particular without a computer working as a Host device connected on said bus, preferably of the USB type, since the system can discriminate between the Host and Function roles of the devices connected thereto. This adds further advantages in terms of power management and battery recharge optimization. In addition, the device according to the invention advantageously allows to supply power to devices, preferably of the USB type, lacking the device according to the invention, as well as to carry out Hub functions in both the Host and Function configurations.

Advantageously, the separate male connector and female connector allow discrimination between the Host and Function configurations depending on the presence or absence of voltage on the male connector. Furthermore, thanks to the adoption of a power voltage detection module, the device according to the invention does not require any additional pin, such as the ID pin in the so-called mini-AB cable described in the USB OTG standard. Preferably, the device according to the invention operates with standard USB interfaces having four pins, two for voltage and ground and two, positive and negative, for data, thus advantageously providing rearward compatibility with USB devices prior to the OTG standard.

Consequently, it being understood the principle of the invention, embodiment details and shapes may vary even significantly from those described and illustrated herein by way of non-limiting example without departing from the scope of the invention, as defined in the following claims.

1-49. (canceled)

50. Mass storage device, comprising:
a memory element with a USB controller adapted to interface said memory element on a four-pin male USB connector for exchanging data;
a module for detecting power voltage associated with a male connector, said USB controller setting said the module to a USB Host device configuration when power voltage is detected through the module or to a Hub/Function configuration when power voltage is not detected; and
a second port adapted to implement a direct data exchange with further USB storage or USB adaptor transferring devices.

51. Method for transferring data to and from a mass storage device, the method comprising the steps of:
interfacing a memory element on a first port for exchanging data according to a data exchange protocol; and
detecting presence of a power voltage associated with a connector of said first port and of setting either a Host or a Function device configuration, according to said data exchange protocol, based on the detection (23) of the presence of a power voltage.

52. Method according to claim 51, further comprising the step of:
providing said mass storage device with a second connector.

53. Method according to claim 52, further comprising the step of:
providing, through said second connector, a connection complementary to said first connector.

54. Method according to claim 51, further comprising the step of:
selecting power voltage of said mass storage device by choosing between power voltage associated with the first connector and battery power voltage according to nature of the devices detected on the first connector or second connector or both.

55. Method according to claim 54, further comprising the step of:
selecting power voltage of a device connected to said second connector by choosing between power voltage associated with the first connector and battery power voltage according to nature of the devices detected on the first connector or second connector or both.

56. Method according to claim 54, wherein the step for selecting the power voltage are controlled, in particular at start-up, by a dedicated circuit, in particular comprised in the logic module, which is self-powered by the battery.

57. Method according to claim 54, further comprising the step of:
controlling battery charge executed in accordance with the values of a control variable available on the bus.

58. Method according to claim 57, wherein said control variable is a service flag file or a file having a specific file extension stored in memory or both.

59. Device according to claim 50, wherein said logic module is set up to operate also as a Hub device, if a device is detected on the female connector.

60. Device according to claim 50, wherein said logic module comprises a logic port to allow said device to be set to said Host or Function configuration according to the USB standard.

61. Device according to claim 50, wherein said logic module comprises a dedicated logic port to allow said device to be set to said USB Host configuration and another dedicated logic port to allow said device to be set to said USB Function configuration.

62. Device according to claim 60, wherein said logic module comprises a dedicated switch, managing the ports to access the memory and said switch status is related to the detection status.

63. Device according to claim 50, further comprising:
a user interface being comprised of a display, selection keys for controlling the data transfer and an on/off key.

64. Device according to claim 50, wherein a USB storage key has embedded flash memory.

65. Device according to claim 50, further comprising:
a wireless data exchange port.

66. Device according to claim 65, wherein said wireless data exchange port is comprised in an adapter associated with said second connector.

67. Device according to claim 50, wherein said logic module has an arbitration function between one or more devices connected thereto according to the detection status.

68. Mass storage device, comprising:
a memory element being a Flash memory or a USB controller adapted to interface said memory element on a four-pin male USB connector for exchanging data; and
a switch controlled and enabled from a personal identification number, managing access of ports to the memory.

69. Device according to claim 68, further comprising:
a user interface, entering and checking the PIN code without depending from other device or Personal Computer.
